(19) United States
(12) Patent Application Publication
(10) Pub. No.: US 2024/0304949 A1
(43) Pub. Date: Sep. 12, 2024

(54) SEPARATOR AND LITHIUM BATTERY EMPLOYING SAME

(71) Applicant: SAMSUNG SDI CO., LTD., Yongin-si, Gyeonggi-do (KR)

(72) Inventors: Keewook KIM, Yongin-si, Gyeonggi-do (KR); Seyeong KANG, Yongin-si, Gyeonggi-do (KR); Minhee KIM, Yongin-si, Gyeonggi-do (KR); Jungjin MOON, Yongin-si, Gyeonggi-do (KR); Sanghyun PARK, Yongin-si, Gyeonggi-do (KR); Bora SHIN, Yongin-si, Gyeonggi-do (KR)

(21) Appl. No.: 18/013,726

(22) PCT Filed: Feb. 25, 2022
(86) PCT No.: PCT/KR2022/002808

§ 371 Date: Feb. 27, 2023

(30) Foreign Application Priority Data
Mar. 5, 2021 (KR) 10-2021-0029589

(51) Int. Cl. H01M 50/489; H01M 10/04; H01M 10/052; H01M 50/417

(52) U.S. Cl. CPC H01M 50/489; H01M 10/0431; H01M 10/052; H01M 50/417

(57) ABSTRACT

Provided are a separator and a lithium battery employing the same. The separator includes a porous substrate having surface irregularities, and an area of protrusion valleys in the surface irregularities of the porous substrate is 12% or more, and less than 40%. The separator may increase insulation through surface morphology control, reduce dV defects, and increase yield and reliability of lithium batteries.

### TECHNICAL FIELD

The present disclosure relates to a separator and a lithium battery employing the same.

### BACKGROUND ART

In accordance with the emergence of various miniaturized, high-performance electronic devices, miniaturization and weight reduction is becoming more important in the field of lithium batteries. In addition, discharge capacity, energy density, and cycle characteristics of lithium batteries are becoming important in order to be applied in fields such as electric vehicles. In order to meet the above needs, a lithium battery having high discharge capacity per unit volume, high energy density, and excellent lifespan characteristics is required.

In a lithium battery, a separator is arranged between a positive electrode and a negative electrode to prevent a short circuit. An electrode assembly, including a positive electrode, a negative electrode, and a separator arranged between the positive electrode and the negative electrode, is wound into a jelly roll shape, and in order to improve adhesion between the positive/negative electrode and the separator in the electrode assembly, the jelly roll is roll-pressed.

As energy density of batteries continues to increase, separators are continuously required to become thinner. As separators become thinner, the distance between a positive electrode and a negative electrode becomes physically closer, and as a result, a frequency of occurrences of a micro-short-circuit inside the battery increases, and dV defects of the battery also increase.

Therefore, a separator capable of reducing dV defects is required.

### DESCRIPTION OF EMBODIMENTS

### Technical Problem

An aspect is to provide a separator capable of reducing dV defects by increasing insulation through surface morphology control.

Another aspect is to provide a lithium battery including the separator.

### Solution to Problem

According to an aspect, provided is a separator, including
a porous substrate having surface irregularities, wherein
in the surface irregularities of the porous substrate, an area of protrusion valleys is 12% or more, and less than 40%.

According to an example, the separator may have a static breakdown voltage (BDV) per unit thickness of 160 V/μm or more.

According to an example, the separator may have a difference between a static BDV and a mobile BDV of 500 V or less.

According to another aspect, provided is a lithium battery, including:
a positive electrode; a negative electrode; and the separator arranged between the positive electrode and the negative electrode.

### Advantageous Effects of Disclosure

The separator according to an aspect may increase insulation through surface morphology control, reduce dV defects, and increase yield and reliability of lithium batteries.

### BRIEF DESCRIPTION OF DRAWINGS

FIG. 1 is a schematic cross-sectional view of a separator for describing a short determination site in the separator.

FIG. 2 is a load curve graph for explaining a loaded area ratio of surface roughness.

FIG. 3 is a schematic diagram of a lithium battery including an electrode assembly wound into a flat jelly roll shape according to an example embodiment.

FIG. 4 is a schematic diagram of a lithium battery including an electrode assembly wound into a cylindrical jelly roll shape according to an example embodiment.

### EXPLANATION OF REFERENCE NUMERALS DESIGNATING MAJOR ELEMENTS OF THE DRAWINGS

1 Lithium battery;
2 Negative electrode;
3 Positive electrode;
4 Separator;
5 Battery case;
6 Cap assembly;
7 Pouch

### MODE OF DISCLOSURE

The present inventive concept described hereinafter may be modified in various ways, and may have many examples, and thus, certain examples are illustrated in the drawings, and are described in detail in the specification. However, this does not intend to limit the present inventive concept within particular embodiments, and it should be understood that the present disclosure includes all the modifications, equivalents, and replacements within the technical scope of the present inventive concept.

Terms used herein were used to describe particular examples, and not to limit the present inventive concept. As used herein, the singular of any term includes the plural, unless the context otherwise requires. The expression of “include” or “have”, used herein, indicates an existence of a characteristic, a number, a phase, a movement, an element, a component, a material, or a combination thereof, and it should not be construed to exclude in advance an existence or possibility of existence of at least one of other characteristics, numbers, movements, elements, components, materials, or combinations thereof. As used herein, “/” may be interpreted to mean “and” or “or” depending on the context.

In the drawings, a thickness is enlarged or reduced to clearly represent various layers and regions. The same reference numerals were attached to similar portions throughout the disclosure. As used herein throughout the disclosure, when a layer, a membrane, a region, or a plate is described to be “on” or “above” something else, it not only includes the case in which it is right above something else but also the case when other portion(s) are present in-between. Terms like “first”, “second”, and the like may be used to describe various components, but the components are not limited by the terms. The terms are used merely for the purpose of distinguishing one component from other components.

Hereinafter, a separator according to example embodiments, and a lithium battery employing the same will be described in more detail.

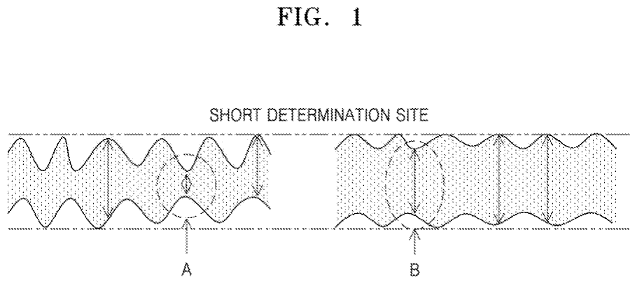

In general, a separator is prone to have a short circuit where a thickness is small. FIG. 1 is a schematic cross-sectional view of a separator for describing a short determination site in the separator. As shown in FIG. 1, a site where the deepest parts of protrusion valleys in the surface irregularities of both surfaces abut each other, that is, a site (for example, site A) where a distance between protrusion valleys on both surfaces is shorter than a site (for example, site B) where a distance between protrusion valleys on both surfaces is long has weak insulation and thus, a short circuit occurs easily. In the separator shown in FIG. 1, site A where a distance between protrusion valleys of both surfaces is the shortest, becomes a short determination site.

In a separator according to an embodiment, surface morphology control is performed to increase insulating properties of the separator.

A separator according to an embodiment includes a porous substrate having surface irregularities, and an area of protrusion valleys in the surface irregularities of the porous substrate is 12% or more, or less than 40%.

The separator has surface irregularities on one surface or both surfaces of the porous substrate, and by controlling the surface morphology so that an area of protrusion valleys in the surface irregularities of the porous substrate is 12% or more, or less than 40%, insulation of the separator may be increased and dV defects may be decreased. And therefore, yield and reliability of lithium batteries may increase.

When an area of protrusion valleys is less than 12%, weak points are concentrated and insulation becomes weak, and when an area of protrusion valleys is 40% or more, wettability for an electrolytic solution becomes very low and thus, resistance of the battery may increase.

A protrusion valley, used herein, is defined as below.

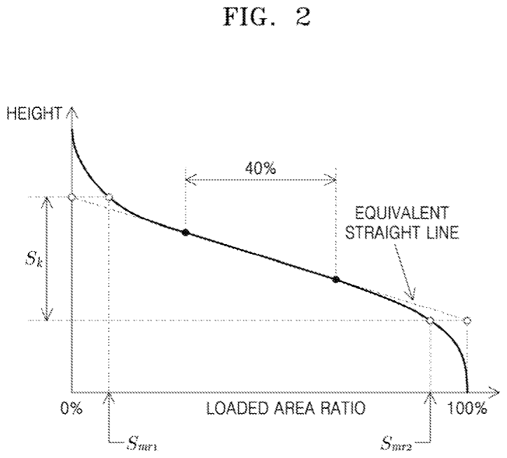

FIG. 2 is a load curve graph for explaining a loaded area ratio of surface roughness. Referring to FIG. 2, a load curve is drawn by measuring surface roughness of a porous substrate of a separator, and in this regard, the surface roughness may be measured based on, for example, ISO25178. Parameters for a loaded area ratio may be calculated by using the load curve.

The term “loaded area ratio” refers to a ratio of a loaded area (area of a region having a height of c or more), with respect to a certain height c in surface roughness. The term “load curve” refers to a curve showing heights at which loaded area ratios are 0% to 100%. The term “equivalent straight line” refers to a straight line for which a squared deviation in the direction of the vertical axis is minimized in a central part, the central part being a position in which a slope of a secant is the gentlest among secants of a load curve having a difference of loaded area ratios of 40%. As shown in FIG. 2, a loaded area ratio corresponding to a point on the load curve corresponding to a value (y-intercept) corresponding to 0% of the loaded area ratio of the equivalent straight line is referred to as Smr1. A loaded area ratio corresponding to a point on the load curve corresponding to a value corresponding to 100% of the loaded area ratio of the equivalent straight line is referred to as Smr2. A portion from Smr1 to Smr2 is called a “core part”, from 0% to Smr1 is called “protrusion peaks”, and Smr2 to 100% is called “protrusion valleys”.

In the load curve graph of FIG. 2, Smr1 indicates a loaded area ratio at an intersection point of a height of an upper part of the core part and the load curve, and Smr2 indicates a loaded area ratio at an intersection point of a height of a lower part of the core part and the load curve. In the load curve graph of FIG. 2, the region corresponding to 0% to Smr1 is protrusion peaks, the region corresponding to Smr1 to Smr2 is a core part, and the region corresponding to Smr2 to 100% is protrusion valleys.

A separator according to an embodiment have an area of protrusion valleys or 12% or more, or 40% or less, which is obtained by surface roughness measurement, in surface irregularities of a porous substrate. For example, an area of protrusion valleys in surface irregularities of a porous substrate may be 13% to 35%, specifically, for example, 15% to 30%. Within the range, insulation of the separator is improved to reduce dV defects.

Insulation of the separator may be evaluated by measuring an insulation breakdown voltage (BDV). A static BDV and a mobile BDV of the separator may be measured by, for example, methods of Evaluation Examples 3 and 4 to be described later.

According to an example, the separator may have a static breakdown voltage (BDV) per unit thickness of 160 V/μm or more. For example, the separator may have a static BDV per unit thickness of 160 V/μm to 200 V/μm. For example, the separator may have a static BDV per unit thickness of 165 V/μm to 180 V/μm. Within the range, the separator may have high insulation and reduced dV defects. Here, as an area of protrusion valleys increases, regions with poor insulation are widely dispersed, and a static BDV value is relatively increased.

According to an example, the separator may have a difference between a static BDV and a mobile BDV of 600 V or less. For example, the separator may have a difference between a static BDV and a mobile BDV of 550 V or less. For example, the separator may have a difference between a static BDV and a mobile BDV of 500 V or less. For example, the separator may have a difference between a static BDV and a mobile BDV of 450 V or less. Within the range, the separator may reduce dV defects while maintaining high insulation. Here, in a separator having a small area of protrusion valleys, weak portions are located concentrated, and the separator becomes more vulnerable than when weak portions are widely distributed, and since a mobile BDV measures a larger area than a static BDV, a difference between the two measurement values may become larger.

The porous substrate included in the separator may be a porous membrane including polyolefin. Polyolefin has an excellent effect of preventing a short circuit, and may also improve stability of a battery by a shutdown effect. For example, the porous substrate may be a membrane consisting of polyolefins such as polyethylene, polypropylene, polybutene, and polyvinyl chloride, and resins such as mixtures or copolymers thereof, but is not necessarily limited thereto and any porous membrane used in the art may be used. For example, a porous membrane consisting of a polyolefin-based resin; a porous membrane made by weaving polyolefin-based fibers; a non-woven fabric including polyolefin; and an aggregate of insulating material particles, may be used. For example, a porous membrane including polyolefin has excellent coating properties for a binder solution which is used to prepare a coating layer formed on the substrate, and a thickness of the separator may be reduced to increase a proportion of active materials in the battery and to increase capacity per unit volume.

The polyolefin used as a material of the porous substrate may be, for example, a homopolymer, a copolymer, or a mixture thereof of polyethylene or polypropylene. Polyethylene may be low-density, medium-density, or high-density polyethylene, and in regards to mechanical strength, high-density polyethylene may be used. In addition, two or more types of polyethylene may be mixed for a purpose of imparting flexibility. A polymerization catalyst used for preparing polyethylene is not particularly limited, and a Ziegler-Natta catalyst, a Phillips catalyst, a metallocene catalyst, or the like may be used. From a viewpoint of achieving both mechanical strength and high permeability, a weight average molecular weight of polyethylene may be 100,000 to 12,000,000, for example, 200,000 to 3,000,000. Polypropylene may be a homopolymer, a random copolymer, or a block copolymer, and may be used alone or in combination of two or more thereof. In addition, a polymerization catalyst is not particularly limited, and a Ziegler-Natta catalyst, or a metallocene catalyst may be used. In addition, stereoregularity is not particularly limited, and isotactic, syndiotactic, or atactic polypropylene may be used, but inexpensive isotactic polypropylene may be selected. In addition, polyolefin other than polyethylene or polypropylene and additives such as antioxidants may be added to the polyolefin within a range that does not impair the effects of the present disclosure.

The porous substrate included in the separator includes, for example, polyolefin such as polyethylene and polypropylene, and a multilayer membrane of two or more layers may be used, and a mixed multilayer membrane such as a polyethylene/polypropylene two-layer separator, a polyethylene/polypropylene/polyethylene three-layer separator, and polypropylene/polyethylene/polypropylene three-layer separator may be used, but is not limited thereto, and any material and configuration that may be used as a porous substrate in the art may be used. The porous substrate included in the separator may include, for example, a diene-based polymer prepared by polymerizing a monomer composition including diene-based monomers. The diene-based monomer may be a conjugated diene-based monomer, or a non-conjugated diene-based monomer. For example, the diene monomer includes at least one selected from the group consisting of 1,3-butadiene, isoprene, 2-chloro-1,3-butadiene, 2,3-dimethyl-1,3-butadiene, 2-ethyl-1,3-butadiene, 1,3-pentadiene, chloroprene, vinylpyridine, vinylnorbornene, dicyclopentadiene, and 1,4-hexadiene, but is not necessarily limited thereto, and any that may be used as a diene-based monomer in the art may be used.

The porous substrate included in the separator may have a thickness of 1 μm to 100 μm. For example, a thickness of the porous substrate may be 1 μm to 50 μm. For example, a thickness of the porous substrate may be 1 μm to 30 μm. For example, a thickness of the porous substrate may be 5 μm to 20 μm. For example, a thickness of the porous substrate may be 5 μm to 15 μm. For example, a thickness of the porous substrate may be 5 μm to 10 μm. When a thickness of the porous substrate is less than 1 μm, it may be difficult to maintain mechanical properties of the separator, and when a thickness of the porous substrate is more than 100 μm, internal resistance of the lithium battery may be increased. Porosity of the porous substrate included in the separator may be 5% to 95%. When the porosity is less than 5%, internal resistance of the lithium battery may increase, and when the porosity is greater than 95%, it may be difficult to maintain mechanical properties of the porous substrate. A pore size of the porous substrate in the separator may be 0.01 μm to 50 μm. For example, the pore size of the porous substrate in the separator may be 0.01 μm to 20 μm. For example, the pore size of the porous substrate in the separator may be 0.01 μm to 10 μm. When the pore size of the porous substrate is less than 0.01 μm, internal resistance of the lithium battery may be increased, and when the pore size of the porous substrate is more than 50 μm, it may be difficult to maintain mechanical properties of the porous substrate.

The above-described separator may be prepared by using, for example, wet and/or dry methods commonly known in the art.

A lithium battery according to another embodiment includes a positive electrode, a negative electrode, and the above-described separator arranged between the positive electrode and the negative electrode. According to an example, the lithium battery includes an electrode assembly including a positive electrode, a negative electrode, and the above-described separator arranged between the positive electrode and the negative electrode, and the electrode assembly may be wound into a jelly roll shape. As a lithium battery includes the above-described separator, black spot defects may be reduced and therefore, quality may be improved, and since adhesion between an electrode (positive electrode and negative electrode) and a separator increases, a volume change during charging and discharging of the lithium battery may be suppressed. Accordingly, deterioration of a lithium battery accompanying a volume change of the lithium battery may be suppressed, and lifespan characteristics of the lithium battery may be improved.

A lithium battery may be prepared, for example, in the following way.

First, a negative electrode composition is prepared by mixing a negative active material, a conductive material, a binder, and a solvent. The negative active material composition may be directly coated on a metal current collector to prepare a negative electrode plate. Alternatively, the negative active material composition may be cast on a separate support and then a film separated from the support may be laminated on a metal current collector to prepare a negative electrode plate. The negative electrode is not limited to the above-described forms, but may have a form other than the forms.

The negative active material may be a carbon-based material. The carbon-based material may be crystalline carbon, amorphous carbon, or a mixture thereof. The crystalline carbon may be graphite such as non-shaped, plate-like, flake-like, spherical, or fibrous natural graphite or artificial graphite, and the amorphous carbon may be soft carbon (low-temperature calcined carbon), or hard carbon, mesophase pitch carbide, calcined coke, and the like.

In addition, a composite of the carbon-based material and a non-carbon-based material may be used as the negative active material, and a non-carbon-based material may be additionally included in addition to the carbon-based material.

The non-carbon-based material may include, for example, at least one selected from the group consisting of a metal capable of forming an alloy with lithium, an alloy of a metal capable of forming an alloy with lithium, and an oxide of a metal capable of forming an alloy with lithium.

For example, the metals alloyable with lithium may be Si, Sn, Al, Ge, Pb, Bi, Sb, and Si—Y alloy (Y may be an alkali metal, alkaline earth metal, group 13 to 16 element, transition metal, rare earth element, or a combination thereof, and is not Si), Sn—Y alloy (Y may be an alkali metal, alkaline earth metal, group 13 to 16 element, transition metal, rare earth element, or a combination thereof, and is not Sn), and the like. The element Y may be, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or a combination thereof.

For example, the transition metal oxide may be lithium titanium oxide, vanadium oxide, or lithium vanadium oxide.

For example, the non-transition metal oxide may be SnO₂, SiOₓ (0<x<2), etc.

Specifically, the negative active material may be at least one selected from the group consisting of Si, Sn, Pb, Ge, Al, SiOx(0<x≤2), SnOy(0<y≤2), Li₄Ti₅O₁₂, TiO₂, LiTiO₃, Li₂Ti₃O₇, but is not limited thereto, and any non-carbon-based negative active material used in the art may be used.

As a conductive material, acetylene black, ketjen black, natural graphite, artificial graphite, carbon black, acetylene black, carbon fiber, metal powder such as copper, nickel, aluminum, or silver may be used, and one kind, or a mixture of one or more kinds of conductive materials such as polyphenylene derivatives may be used, but it is not limited thereto, and any material that may be used as a conductive material in the art may be used. In addition, the above-described crystalline carbon-based material may be added as a conductive material.

Examples of the binder include vinylidene fluoride/hexafluoropropylene copolymer, polyvinylidene fluoride (PVDF), polyacrylonitrile, polymethylmethacrylate, polytetrafluoroethylene (PTFE), mixtures thereof, or styrene butadiene rubber-based polymer or the like, but it is not necessarily limited thereto, and any binder used in the art may be used.

N-methylpyrrolidone, acetone, or water may be used as the solvent, but the solvent is not limited thereto, and any solvent that may be used in the art may be used.

Contents of the negative active material, conductive material, binder, and solvent are levels commonly used in lithium batteries. Depending on an intended use and configuration of the lithium battery, one or more of the conductive material, binder, and solvent may be omitted.

Meanwhile, the binder used for preparing the negative electrode may be the same as the coating composition included in the coating layer of the separator.

Next, a positive electrode composition is prepared by mixing a positive active material, a conductive material, a binder, and a solvent. The positive active material composition may be directly coated on a metal current collector to prepare a positive electrode plate. Alternatively, the positive active material composition may be cast on a separate support and then a film separated from the support may be laminated on a metal current collector to prepare a positive electrode plate.

At least one selected from lithium cobalt oxide, lithium nickel cobalt manganese oxide, lithium nickel cobalt aluminum oxide, lithium iron phosphate, and lithium manganese oxide may be included as a positive active material, but the positive active material is not limited thereto, and all that may be used as a positive active material in the art may be used.

For example, a compound represented by any one of the following formulas may be used: LiₐA_{1-b}B_{b}D₂ (wherein 0.90≤a≤1.8, and 0≤b≤0.5); LiₐE_{1-b}B_{b}O_{2-c}D_{c} (wherein 0.90≤a≤1.8, 0≤b≤0.5, and 0≤c≤0.05); LiE_{2-b}B_{b}O_{4-c}D_{c} (wherein 0≤b≤0.5, and 0≤c≤0.05); LiₐNi_{1-b-c}Co_{b}B_{c}D_{α} (wherein 0.90≤a≤1.8, 0≤b≤0.5, 0≤c≤0.05, and 0<α≤2); LiₐNi_{1-b-c}Co_{b}B_{c}O_{2-α}F_{α} (wherein 0.90≤a≤1.8, 0≤b≤0.5, 0≤c≤0.05, and 0<α<2); LiₐNi_{1-b-c}Co_{b}B_{c}O_{2-α}F₂ (wherein 0.90≤a≤1.8, 0≤b≤0.5, 0≤c≤0.05, and 0<α<2); LiₐNi_{1-b-c}Mn_{b}B_{c}D_{α} (wherein 0.90≤a≤1.8, 0≤b≤0.5, 0≤c≤0.05, and 0<α≤2); LiₐNi_{1-b-c}Mn_{b}B_{c}O_{2-α}F_{α} (wherein 0.90≤a≤1.8, 0≤b≤0.5, 0≤c≤0.05, and 0<α<2); LiₐNi_{1-b-c}Mn_{b}B_{c}O_{2-α}F₂ (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.9, 0≤c≤0.5, and 0.001≤d≤0.1.); LiₐNi_{b}Co_{c}Mn_{d}GeO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8, and 0.001≤b≤0.1); LiₐCoG_{b}O₂ (wherein 0.90≤a≤1.8, and 0.001≤b≤0.1); LiₐMnG_{b}O₂ (wherein 0.90≤a≤1.8, and 0.001≤b≤0.1); LiₐMn₂G_{b}O₄ (wherein 0.90≤a≤1.8, and 0.001≤b≤0.1); QO₂; QS₂; LiQS₂; V₂O₅; LiV₂O₅; LiIO₂; LiNiVO₄; Li_{(3-f)}J₂(PO₄)₃ (0≤f≤2); Li_{(3-f)}Fe₂(PO₄)₃ (0≤f≤2); and LifePO₄.

In these formulas, A may be Ni, Co, Mn, or a combination thereof; B may be Al, Ni, Co, Mn, Cr, Fe, Mg, Sr, V, a rare earth element, or a combination thereof; D may be O, F, S, P, or a combination thereof; E may be Co, Mn, or a combination thereof; F may be F, S, P, or a combination thereof; G may be Al, Cr, Mn, Fe, Mg, La, Ce, Sr, V, or a combination thereof; Q may be Ti, Mo, Mn, or a combination thereof; I may be Cr, V, Fe, Sc, Y, or a combination thereof; and J may be V, Cr, Mn, Co, Ni, Cu, or a combination thereof.

A compound with a coating layer on a surface of the above-mentioned compound may be used, or a mixture of the above-mentioned compound and the compound with a coating layer may be used. The coating layer may include a compound of a coating element, such as an oxide of a coating element, a hydroxide of a coating element, an oxyhydroxide of a coating element, an oxycarbonate of a coating element, or a hydroxycarbonate of a coating element. Compounds constituting the coating layer may be amorphous or crystalline. As the coating element included in the coating layer, Mg, Al, Co, K, Na, Ca, Si, Ti, V, Sn, Ge, Ga, B, As, Zr, or mixtures thereof may be used. In a process of forming the coating layer, any coating method (for example, spray coating, an immersion method, etc.) may be used as long as the compound may be coated in a way that does not adversely affect physical properties of the positive active material by using these elements, and since this may be well understood by those skilled in the art, a detailed description thereof will be omitted.

For example, LiNiO₂, LiCoO₂, LiMnₓO₂ₓ (x=1, or 2), LiNi₁₋ₓMnₓO₂ (0<x<1), LiNi_{1-x-y}CoₓMn_{y}O₂ (0≤x≤0.5, and 0≤y≤0.5), LiFeO₂, V₂O₅, TiS, MoS, and the like may be used.

In the positive active material composition, the conductive material, the binder, and the solvent may be the same as those in the negative active material composition.

Meanwhile, it is also possible to form pores inside the electrode plate by adding a plasticizer to the positive active material composition and the negative active material composition.

Contents of the positive active material, conductive material, general binder, and solvent are levels commonly used in lithium batteries. Depending on an intended use and configuration of the lithium battery, one or more of the conductive material, binder, and solvent may be omitted.

Meanwhile, the binder used for preparing the positive electrode may be the same as the coating composition included in the coating layer of the separator.

Next, the above-described composite separator is arranged between the positive electrode and the negative electrode.

In an electrode assembly including a positive electrode/separator/negative electrode, the separator arranged between the positive electrode and the negative electrode includes a porous substrate; and a coating layer arranged on both surfaces of the porous substrate, as described above, wherein the coating layer includes the above-described composition for coating a separator.

A separator may be separately prepared and arranged between the positive electrode and the negative electrode. Alternatively, the separator may be prepared by: winding the electrode assembly including the positive electrode/separator/negative electrode into a jelly roll shape, then accommodating the jelly roll in a battery case or pouch; pre-charging the jelly roll accommodated in a battery case or pouch while thermally softening the jelly roll under pressure; hot rolling the charged jelly roll; cold rolling the filled jelly roll; and going through a formation process of charging and discharging the charged jelly roll under pressure.

Next, an electrolyte is prepared.

The electrolyte may be in a liquid or gel state.

For example, the electrolyte may be an organic electrolytic solution. Also, the electrolyte may be solid. The electrolyte may be, for example, a boron oxide, lithium oxynitride, and the like, but is not limited thereto, and all that may be used as a solid electrolyte in the related art may be used. The solid electrolyte may be formed on the negative electrode by a method such as sputtering.

For example, an organic electrolytic solution may be prepared. The organic electrolytic solution may be prepared by dissolving a lithium salt in an organic solvent.

For the organic solvent, all that may be used as an organic solvent in the art may be used. The organic solvent may be, for example, carbonates such as propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, and dibutyl carbonate, propionates such as ethyl propionate, methyl propionate, and propyl propionate, benzonitrile, acetonitrile, tetrahydrofuran, 2-methyltetrahydrofuran, γ-butyrolactone, dioxolane, 4-methyldioxolane, N,N-dimethylformamide, N,N-dimethylacetamide, dimethyl sulfoxide, dioxane, 1,2-dimethoxyethane, sulfolane, dichloroethane, chlorobenzene, nitrobenzene, diethylene glycol, dimethyl ether, or a mixture thereof.

For the lithium salt, all that may be used as a lithium salt in the art may be used. For example, LiCI, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, (FSO₂)₂NLi, lithium chloroborate, compounds represented by the following formulas, a mixture or a combination thereof may be used.

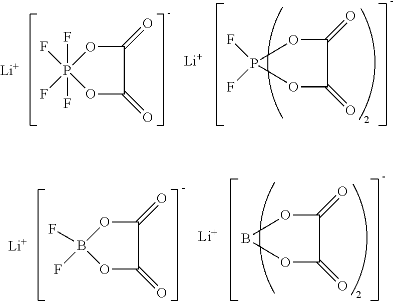

A content of the lithium salt may be, for example, 0.1 M to 5 M.

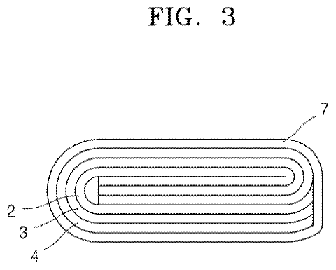

As shown in FIG. 3, the lithium battery 1 includes a positive electrode 3, a negative electrode 2, and a composite separator 4. After the positive electrode 3, the negative electrode 2, and the separator 4 are wound into an electrode assembly in a flat jelly roll shape, the electrode assembly is accommodated in a pouch 7. Then, an organic electrolytic solution is injected into the pouch 7 and the pouch is sealed to complete the lithium battery 1.

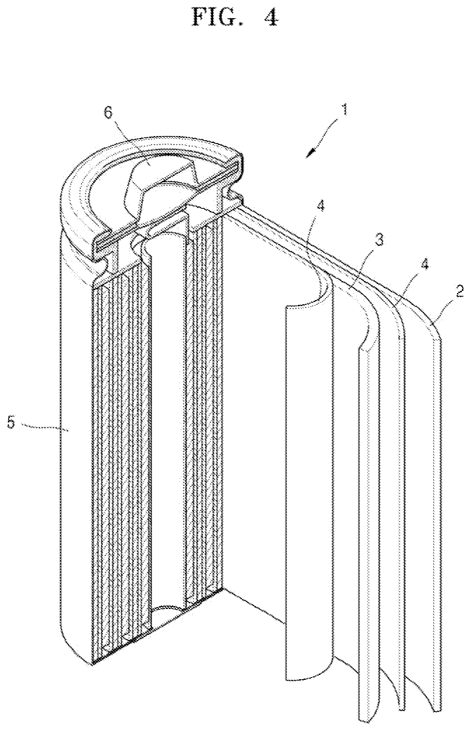

As shown in FIG. 4, the lithium battery 1 includes a positive electrode 3, a negative electrode 2, and a separator 4. After the positive electrode 3, the negative electrode 2, and the separator 4 are wound into an electrode assembly in a cylindrical jelly roll shape, the electrode assembly is accommodated in a battery case 5. Subsequently, an organic electrolytic solution is injected into the battery case 5 and the battery case is sealed with a cap assembly 6 to complete a lithium battery 1. The battery case may be a cylindrical shape, a prismatic shape, or a thin film type. The lithium battery may be a lithium-ion battery. The lithium battery may be a lithium polymer battery.

Since the lithium battery is excellent in high-rate characteristics and lifespan characteristics, the lithium battery is suitable to be used in electrical vehicles (EV). For example, the lithium battery may be suitable for a hybrid vehicle such as plug-in hybrid electric vehicle (PHEV).

The present inventive concept is explained in more detail through the following examples and comparative examples. However, the examples are for exemplifying the present inventive concept, and the scope of the present inventive concept is not limited thereto.

### Example 1

### (Preparation of Separator)

A separator having a thickness of 20 μm and an area of protrusion valleys of 15% was prepared. The area of the protrusion valleys was measured by the method of Evaluation Example 1.

### (Preparation of Negative Electrode)

97 wt % of graphite particles with an average particle diameter of 25 μm, 1.5 wt % of styrene-butadiene rubber (SBR) binder, and 1.5 wt % of carboxymethylcellulose (CMC) were mixed, and then put in distilled water, and stirred for 60 minutes by using a mechanical stirrer to prepare negative active material slurry. The slurry was applied on a 10 μm thick copper current collector by using a doctor blade, dried in a hot air dryer at 100° C. for 0.5 hours, dried again for 4 hours under vacuum conditions at 120° C., and then roll-pressed, to prepare a negative electrode plate.

### (Preparation of Positive Electrode)

97 wt % of LiCoO₂, 1.5 wt % of carbon black powder as a conductive material, and 1.5 wt % of polyvinylidene fluoride (PVDF) were mixed, put into an N-methyl-2-pyrrolidone solvent, and stirred for 30 minutes by using a mechanical stirrer to prepare positive active material slurry. The slurry was applied on a 20 μm thick aluminum current collector by using a doctor blade, dried in a hot air dryer at 100° C. for 0.5 hours, dried again for 4 hours under vacuum conditions at 120° C., and then roll-pressed, to prepare a positive electrode plate.

### (Preparation of Lithium Battery-Preparation of Electrode Assembly Jelly Roll)

An electrode assembly jelly roll was prepared by interposing a separator between the positive electrode plate and the negative electrode prepared above, and then winding. After inserting the jelly roll into a pouch and injecting an electrolytic solution, the pouch was vacuum-sealed.

As the electrolytic solution, a mixed solution of ethylene carbonate (EC), ethylmethyl carbonate (EMC), and diethyl carbonate (DEC) mixed in a volume ratio of 3:5:2, into which 1.3 M of LiPF₆ was dissolved, was used.

The jelly roll inserted into a pouch was subjected to thermal softening at a temperature of 70° C. for 1 hour while applying a pressure of 250 kgf/cm², and was pre-charged to a state of charge (SOC) of 50%.

The jelly roll was heat-pressed at a temperature of 85° C. for 180 seconds, while applying a pressure of 200 kgf/cm² to the jelly roll. In the hot-rolling process, as the binder is converted from a gel state to a sol state, adhesion is generated between the positive electrode/negative electrode and the separator.

Subsequently, the jelly roll was cold-pressed at a temperature of 22° C. to 23° C. for 90 seconds while applying a pressure of 200 kgf/cm² to the jelly roll. During the hot-rolling process, the binder was converted from a sol state to a gel state.

Subsequently, the pouch was degassed, and the jelly roll was charged at a constant current of 0.2 C rate until the voltage reached 4.3 V, and then, while maintaining a constant voltage of 4.3 V, charged until the current reached 0.05 C, at a temperature of 45° C. for 1 hour, while applying a pressure of 200 kgf/cm². Subsequently, the jelly roll was discharged at a constant current of 0.2 C until the voltage reached 3.0 V, and the cycle was repeated 5 times to perform a formation process.

### Example 2

A lithium battery was prepared in the same manner as in Example 1, except that a separator having a thickness of 14 μm, and an area of protrusion valleys of 17% was used.

### Example 3

A lithium battery was prepared in the same manner as in Example 1, except that a separator having a thickness of 6 μm, and an area of protrusion valleys of 20% was used.

### Example 4

A lithium battery was prepared in the same manner as in Example 1, except that a separator having a thickness of 20 μm, and an area of protrusion valleys of 30% was used.

### Comparative Example 1

A lithium battery was prepared in the same manner as in Example 1, except that a separator having a thickness of 20 μm, and an area of protrusion valleys of 11% was used.

### Comparative Example 2

A lithium battery was prepared in the same manner as in Example 1, except that a separator having a thickness of 14 μm, and an area of protrusion valleys of 10.5% was used.

### Comparative Example 3

A lithium battery was prepared in the same manner as in Example 1, except that a separator having a thickness of 6 μm, and an area of protrusion valleys of 11% was used.

### Comparative Example 4

A lithium battery was prepared in the same manner as in Example 1, except that a separator having a thickness of 20 μm, and an area of protrusion valleys of 40% was used.

### Evaluation Example 1: Measurement of Area of Protrusion Valleys of Separator

Each of the separators used in Examples 1 to 4 and Comparative Examples 1 to 4 was flatly spread on a slide glass and its four sides were fixed to prepare samples. The samples were placed on a 3D microscope (KEYENCE VK-X model) and the surfaces of the samples were observed with a x50 lens.

After measuring roughness according to ISO 25178 and drawing a load curve according to a thickness, an area of protrusion valleys corresponding to (100-SMR2) % was calculated.

The calculated area of the protrusion valleys is shown in Table 1 below.

### Evaluation Example 2: Measurement of Static BDV

A steel use stainless (SUS) plate was connected to the (−) electrode of a voltage tester KIKUSUI (TOS-5300), and a broom-shaped probe was connected to the (+) electrode. The current was set to a direct current (DC) mode, the voltage was raised to 4,500 V for 8 seconds, and the detection voltage was set to 0.3 mA.

Each of the separators used in Examples 1 to 4 and Comparative Examples 1 to 4 was spread flat on a SUS plate, and the probe was placed on the separator, and a voltage at which the voltage rise stops (breakdown, short) was measured, and the voltage was taken as a static breakdown voltage (BDV) value.

The measured static BDV value and the static BDV value per unit thickness are shown in Table 1 below.

### Evaluation Example 3: Measurement of Mobile BDV

An initial voltage was set as the [static BDV-500] V value measured in Evaluation Example 2, and when the set voltage was reached, the probe was moved in the machine direction (MD) for 8 seconds without being detached from the separator. When a breakdown occurs in the separator by moving the probe and current flows, the voltage was set to +100 V and the method was repeated, and when the current stopped flowing because a breakdown did not occur 3 consecutive times, this voltage was set as a mobile BDV value.

The measured mobile BDV value, the static BDV, and the difference between the static BDV and the mobile BDV are shown in Table 1 below.

### Evaluation Example 4: Measurement of dV Defect Rate

The lithium batteries prepared in Examples 1 to 4 and Comparative Examples 1 to 4 were charged up to 30% of the capacity, aged at room temperature for 24 hours, an open circuit voltage (OCV) was measured, and 80 hours later, OCV was measured again. The measured OCV values were averaged, and a cell having OCV 0.4 mV or more lower than the average was defined as having a dV defect. A dV defect rate was measured by the above method, and the results are shown in Table 1 below.

### Evaluation Example 5: Measurement of Cell Resistance

An ion-blocking cell for resistance measurement was prepared by using each of the separators used in Examples 1 to 4 and Comparative Examples 1 to 4 and the electrolytic solution obtained according to the method described below.

As the electrolytic solution, a solution including 1.1 M of LiPF₆ dissolved in a solvent in which ethylene carbonate (EC), ethyl methyl carbonate (EMC), and dimethyl carbonate (DMC) were mixed in a volume ratio of 3:4:3, was used. In addition, in the preparation of the ion-blocking cell, after cutting the separator into a circular shape with a diameter of 19 mm, the separator was placed on top of a case, a gasket was placed thereon, and 1 to 2 drops of the electrolytic solution were dropped thereon. After placing a spacer having a thickness of 1 mm thereon, a spacer having a thickness of 0.5 mm was placed thereon. Subsequently, a spring was placed on top of the resulting product to prevent a gap between an upper part and a lower part inside CR2032, and a cap was placed on it to seal it in a clamper used for the purpose only. When preparing CR2032, Hohsen's CR2032 material was used.

Resistance of the ion-blocking cell 6 hours after the injection of the electrolytic solution was measured by using electrochemical impedance spectroscopy (EIS), and the results are shown in Table 1 below.

TABLE 1

| | | | | | | | | Resistance |
|---|---|---|---|---|---|---|---|---|
| | | | | Static | | Static | | of cell 6 |
| | | Area of | | BDV per | | BDV − | dV defect | hours after |
| | | protrusion | Static | unit | Mobile | Mobile | rate/ | electrolyte |
| | Thickness | valleys | BDV | thickness | BDV | BDV | thickness | injection |
| | (μm) | (%) | (V) | (V/μm) | (V) | (V) | (ppm/μm) | (mΩ) |
| Example 1 | 20 | 15 | 3456 | 172.8 | 3,000 | 456 | 50 | 0.020 |
| Example 2 | 14 | 17 | 2347 | 167.6 | 2,000 | 347 | 51 | 0.015 |
| Example 3 | 6 | 20 | 1,079 | 179.8 | 600 | 479 | 49 | 0.012 |
| Example 4 | 20 | 30 | 3,444 | 172.2 | 3,100 | 344 | 48 | 0.025 |
| Comparative | 20 | 11 | 2,631 | 131.6 | 1,900 | 731 | 100 | 0.020 |
| Example 1 | | | | | | | | |
| Comparative | 14 | 10.5 | 2,153 | 153.8 | 1,500 | 653 | 103 | 0.015 |
| Example 2 | | | | | | | | |
| Comparative | 6 | 11 | 850 | 141.7 | 200 | 650 | 98 | 0.012 |
| Example 3 | | | | | | | | |
| Comparative | 20 | 40 | 3,420 | 171.0 | 3,200 | 220 | 43 | 0.300 |
| Example 4 | | | | | | | | |

As shown in Table 1, it may be seen that the separators of Examples 1 to 4 had decreased dV defects due to having increased insulation compared to the separators of Comparative Examples 1 to 4. It may be seen that when an area of the protrusion valleys was 40% or more (Comparative Example 4), wettability for electrolytic solution become very low and resistance of the battery increased.

Hitherto embodiments have been described with reference to drawings and examples, but these are only illustrative, and those skilled in the art will be able to understand that various modifications and equivalent other embodiments are possible therefrom. Therefore, the scope of the present disclosure should be defined by the appended claims.

1. A separator comprising a porous substrate having surface irregularities, wherein in the surface irregularities of the porous substrate, an area of protrusion valleys is 12% or more, and less than 40%.

2. The separator of claim 1, wherein in the surface irregularities of the porous substrate, an area of protrusion valleys is 15% to 30%.

3. The separator of claim 1, wherein the separator has a static BDV per unit thickness of 160 V/μm or more.

4. The separator of claim 1, wherein the separator has a static BDV per unit thickness of 160 V/μm to 200 V/μm.

5. The separator of claim 1, wherein in the separator, a difference between a static BDV and a mobile BDV is 600 V or less.

6. The separator of claim 1, wherein a thickness of the porous substrate is 1 μm to 100 μm.

7. The separator of claim 1, wherein the porous substrate is a porous substrate comprising polyolefin.

8. A lithium battery comprising: a positive electrode; a negative electrode; and a separator as claimed in claim 1.

9. The lithium battery of claim 8, wherein in the lithium battery, an electrode assembly comprising the positive electrode, the negative electrode, and the separator is wound into a jelly roll shape.
